(19) United States
(12) Patent Application Publication
(10) Pub. No.: US 2014/0340364 A1
(43) Pub. Date: Nov. 20, 2014

(54) TOUCH DISPLAY PANEL

(71) Applicant: AU Optronics Corp., Hsin-Chu (TW)

(72) Inventors: Yu-Ying Tang, Hsin-Chu (TW); An-Cheng Chen, Hsin-Chu (TW); Ya-Wei Deng, Hsin-Chu (TW); Shih-Po Chou, Hsin-Chu (TW)

(73) Assignee: AU Optronics Corp., Hsin-Chu (TW)

(21) Appl. No.: 14/277,787

(22) Filed: May 15, 2014

(30) Foreign Application Priority Data
May 16, 2013 (TW) 102117416

(51) Int. Cl. G06F 3/042

(52) U.S. Cl. CPC G06F 3/042
USPC 345/175

(57) ABSTRACT

A touch display panel includes a substrate, touch sensing elements, a light-shielding layer, a first patterned light-shielding layer, and a display module. The substrate has a display zone and a non-display zone. The non-display zone includes at least one first patterned transparent region. The touch sensing elements is disposed in the display zone. The light-shielding layer covers the first patterned transparent region and has a first transmittance rate. The first patterned light-shielding layer partially covers the light-shielding layer and is not disposed in the first patterned transparent region. The first patterned light-shielding layer has a second transmittance rate. The second transmittance rate is substantially less than the first transmittance rate.

### BACKGROUND OF THE INVENTION

1. Field of the Invention

The present invention relates to a touch display panel, and more particularly, to a touch display panel whose periphery frames on a surface thereof is capable of displaying a button pattern or particular patterns.

2. Description of the Prior Art

Touch display panels have been widely used in various information products, such as tablet and smart phone. In order to obtain attractive appearance and convenience at the same time, a display panel may have touch buttons disposed within a periphery frame thereof allowing further operation. One of current designs is carried out by using backlight on those touch buttons of the information product in operation mode, with those touch buttons functioning like an illuminating button. Once the information product is in standby mode, patterns of those touch buttons will no longer reveal or only reveal vaguely on the surface of the information product since the backlight has been turned off. However, for the sake of obtaining aforementioned functions, a light guide film has to be coated on the backside of the touch buttons, so that each touch button can illuminate evenly with its whole pattern in operation mode. Additionally, in order to achieve vaguely revealing or hiding touch buttons in standby mode, the light guide film has to be in a color which is similar to other parts of the surface of the information product. Accordingly, for the manufacturers, it is time consuming to select and prepare a proper color for the light guide film during the fabrication thereof. Hence, it is obvious that said fabrication of the touch buttons (with light guide film) is time-and-cost consuming and it is needed to further improve the structure, as well as the fabrication of the touch buttons or the touch display panel.

### SUMMARY OF THE INVENTION

It is one of the objectives of the present invention to provide a touch display panel which allows a touch button thereon to provide illuminating function via a light-shielding layer.

To achieve the purpose described above, the present invention provides a touch display panel comprising a substrate, a plurality of touch sensing elements, a light-shielding layer, a first patterned light-shielding layer and a display module. The substrate has a display zone and a non-display zone surrounding the display zone, and the non-display zone includes at least one first patterned transparent region. The touch sensing elements are disposed within the display zone. The light-shielding layer covers the first patterned transparent region of the substrate and has a first transmittance rate. The first patterned light-shielding layer partially covers the light-shielding layer, the first patterned light-shielding layer is not disposed within the first patterned transparent region, and the first patterned light-shielding layer has a second transmittance rate which is substantially less than the first transmittance rate. The display module is disposed on the substrate, and the touch sensing elements are disposed between the display and the substrate.

Through the present invention, since there is a light-shielding layer disposed within the first patterned transparent region of the touch display panel which has a button pattern, a difference of the thickness and the transmittance rate between the first patterned transparent region and other portions of the non-display zone occur such that the transmittance rate of the first patterned transparent region with the button pattern is higher and sufficient and therefore the button pattern can function as an illuminating button in a circumstance with backlight. With such structure of the touch display panel in the present invention, a light guide film is no longer requested to be coated on the backside of the button, so as to reduce the fabrication cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a top view of the touch display panel of the first embodiment of the present invention.

FIG. 2 to FIG. 5 are enlarged cross-sectional views along the cross line 2-2′ of the touch display panel shown in FIG. 1 and illustrating the fabrication process of the touch display panel.

FIG. 6 is a graph illustrating a relation between the transmittance rates of materials and the thicknesses of coated layers.

FIG. 7 is a schematic top view of a touch display panel of the present invention in standby mode.

FIG. 8 is a schematic top view of a touch display panel of the present invention in operation mode.

FIG. 9 is a schematic top view of an outward appearance of the touch display panel of the second embodiment of the present invention.

FIG. 10 is a cross-sectional view along the cross line 9-9′ and of the touch display panel shown in FIG. 9.

FIG. 11 is cross-sectional view along the cross line 10-10′ of the touch display panel shown in FIG. 9.

FIG. 12 is a cross-sectional view of a touch display panel in accordance with a third embodiment of the present invention.

### DETAILED DESCRIPTION

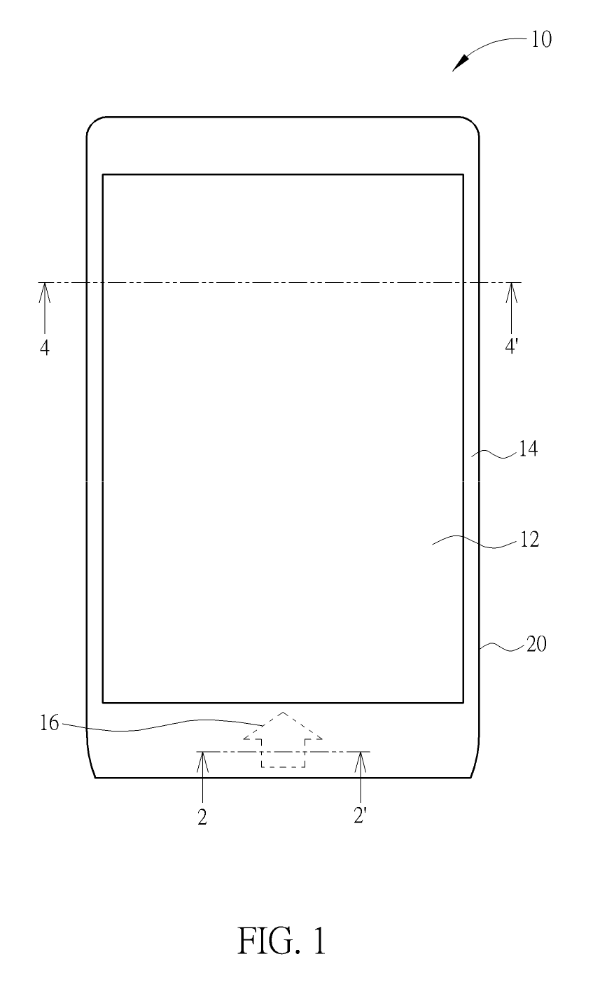

Referring to FIG. 1 to FIG. 5, FIG. 1 to FIG. 5 are schematic diagrams of a fabrication and a structure of a touch display panel of the present invention, wherein FIG. 1 is a top view of the touch display panel in accordance with the first embodiment of the present invention. In view of FIG. 1, the touch display panel 10 can be used in various portable information products, such as but not limited to smart phones, and can be further applied to any devices requiring a display panel or a display interface. The touch display panel 10 includes a substrate 20 which includes a display zone 12 and a non-display zone 14, wherein the non-display zone 14 preferably surrounds the display zone 12. The non-display zone 14 includes at least one first patterned transparent region 16, wherein the first patterned transparent region 16 can be regarded as a predetermined illuminating pattern region which is planned for disposing an illuminating pattern, such as a touch button or a trademark, on the touch display panel 10. As an example, the first patterned transparent region 16 may have a pattern in a similar shape of a house, and a touch button which can function as a home button is disposed in a corresponding region thereby accordingly. Moreover, except for the first patterned transparent region 16 of the non-display zone 14 of the substrate 20, other portion of the non-display zone 14 can all be regarded as a light-shielding region.

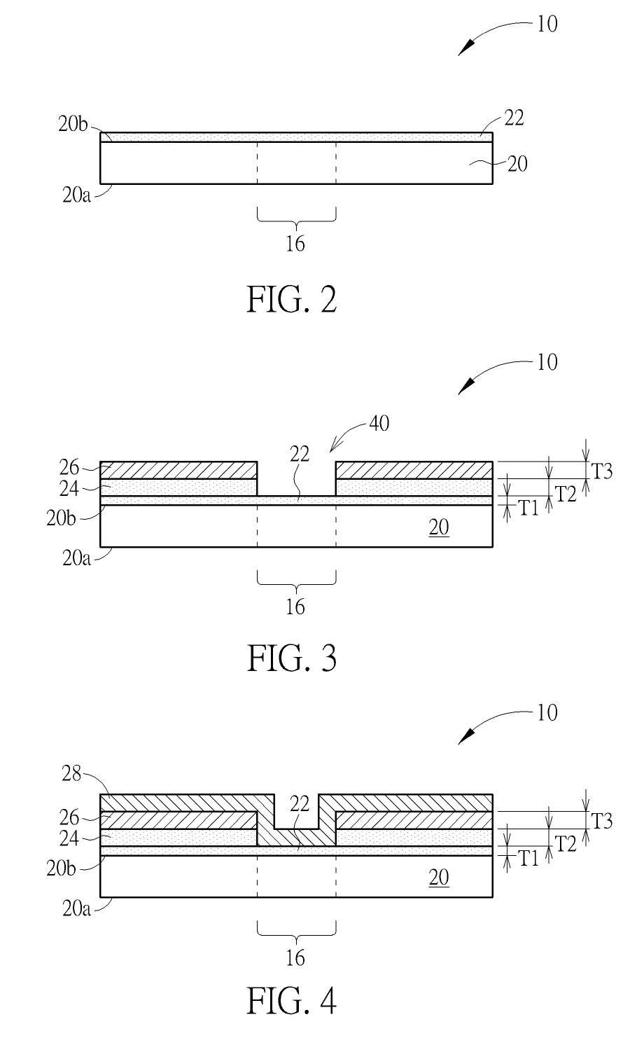

The present invention provides a fabrication method of a touch display panel 10 having an illuminating pattern or an illuminating button. FIG. 2 to FIG. 4 are enlarged cross-sectional views along the cross line 2-2′ of the touch display panel 10 shown in FIG. 1, and which are used for explaining the fabrication process of the touch display panel 10 of the present invention. In FIG. 2, the substrate 20 has a bottom surface 20a being regarded as a display surface of the touch display panel 10. First of all, a light-shielding layer 22 is formed entirely in the non-display zone 14 on a top surface 20b of the substrate 20 through a coating or photolithography process, wherein the light-shielding layer 22 covers the first patterned transparent region 16. In an example, the light-shielding layer 22 is formed entirely on the top surface 20b followed by removing a portion of the light-shielding layer 22 within the display zone 12 through the photolithography process, or the light-shielding layer 22 is formed on the non-display zone 14 directly through a screen printing or coating process. Next, referring to FIG. 3, a second patterned light-shielding layer 24 and a first patterned light-shielding layer 26 are sequentially formed on the surface of the light-shielding layer 22 in the non-display zone 14, wherein the second patterned light-shielding layer 24 only partially covers the light-shielding layer 22 and is disposed in the portion of the non-display zone 14 which does not have the first patterned transparent layer 16. Namely the second patterned light-shielding layer 24 is not disposed within the first patterned transparent layer 16. The first patterned light-shielding layer 26 covers the surface of the second patterned light-shielding layer 24 and the second patterned light-shielding layer 24 has a pattern which is the same as a pattern of the first patterned light-shielding layer 26. In other words, the second patterned light-shielding layer 24 and the first patterned light-shielding layer 26 have an opening 40 which is in the same shape of the first patterned transparent region 16, as well as the pattern of the predetermined illuminating pattern. Therefore, the opening 40 of the second patterned light-shielding layer 24 and the first patterned light-shielding layer 26 exposes the first patterned transparent region 16 and the light-shielding layer 22 within the first patterned transparent region 16. After that, as shown in FIG. 4, a touch sensing layer 28 can be formed on a surface of the substrate 20, and which covers the light-shielding layer 22 within the first patterned transparent region 16 and at least a portion of the first patterned light-shielding layer 26, thus the first patterned transparent region 16 can function as a touch button.

Further referring to FIG. 4, the light-shielding layer 22, the first patterned light-shielding layer 26 and the second patterned light-shielding layer 24 have a first transmittance rate, a second first transmittance rate, and a third transmittance rate respectively, wherein the second transmittance rate is substantially less than a sum of the first transmittance rate and the third transmittance rate. It is noted that, since the first patterned transparent region 16 only has a single layer of the light-shielding layer 22 thereon, the transmittance rate of the first patterned transparent region 16 will be higher than the transmittance rate of the other portion of the non-display zone 14 which simultaneously has the light-shielding layer 22, the second pattern light-shielding layer 24 and the first pattern light-shielding layer 26 thereon, wherein the above-mentioned term “the other portion of the non-display zone 14” means the area of the non-display zone 14 excluding the first patterned transparent region 16. In the present embodiment, the first transmittance rate has a range substantially between about 10% and about 20%. The light-shielding layer 22 includes a material which is the same as a material of the second patterned light-shielding layer 24 but is different from a material of the first patterned light-shielding layer 26. As an example, the material of the light-shielding layer 22 and the second patterned light-shielding layer 24 includes white ink or white photoresist material, with both of them either having the same or different transmittance rate substantially. The material of the first patterned light-shielding layer 26 includes black ink, black photoresist material or other materials which can be used on black matrix (BM), such that the second transmittance rate is substantially less than the first transmittance rate. The white ink as mentioned above includes titanium dioxide and organic polyester resin, for example, comprising organic polyester resin as a base incorporated with titanium dioxide for toning. The white photoresist material as mentioned above includes titanium dioxide and acryl resin, for example, comprising acryl resin as a base incorporated with titanium dioxide for toning. Besides, for example, the black ink as mentioned above includes carbon black and organic polyester resin and the black photoresist material as mentioned above includes carbon black and acryl resin. As an example, the black ink and black photoresist material may include organic polyester resin and acryl resin respectively as a base incorporated with carbon black for toning respectively. While fabricating the second patterned light-shielding layer 24 and the first patterned light-shielding layer 26 with coating materials, it can be conducted via a screen printing process, thus that the second patterned light-shielding layer 24 and the first patterned light-shielding layer 26 will have a particular pattern, namely the opening 40, to expose the light-shielding layer 22 within the first pattern transparent region 16. In another aspect, while fabricating the second patterned light-shielding layer 24 and the first patterned light-shielding layer 26 with photoresist materials, it can be conducted via a photolithography process. In the present embodiment, the second patterned light-shielding layer 24 is disposed mainly for avoiding the first patterned light-shielding layer 26 in black or dark color being revealed from the light-shielding layer 22. In other embodiments, if the light-shielding layer 22 includes an ink having higher color saturation, such as blue ink or red ink, it is possible to omit the fabrication of the second patterned light-shielding layer 24 and to only form the first patterned light-shielding layer 26 having a less transmittance rate on the light-shielding layer 22, so as to shield the periphery circuits or wires disposed within the non-display zone 14 of the touch display panel 10, but not limited thereto.

In a preferred embodiment, the light-shielding layer 22 has a thickness T1 less than a thickness T2 of the second patterned light-shielding layer 24 or a thickness T3 of the first patterned light-shielding layer 26, but not limited thereto. In other embodiments, the thickness T1 of the light-shielding layer 22 can be optionally the same as the thickness T3 of the first patterned light-shielding layer 26 or the thickness T1 can be only less than the thickness T2 of the second patterned light-shielding layer 24 but not less than the thickness T3 of the first patterned light-shielding layer 26. In the present embodiment, the light-shielding layer 22 is consisted of white ink and has the thickness T1 with a range from about 4 micrometers to about 8 micrometers. It is noted that, the touch display panel 10 of the present invention obtains different transmittance rates in the first patterned transparent region 16 and the other portion of the non-display zone 14 by taking the difference of the thickness or number of formed layers of the light-shielding layers in these two different regions. Taking the present embodiment as an example, since the first patterned transparent region 16 only has the light-shielding layer 22 thereon, the first transmittance rate of the light-shielding layer 22 can be considered as the transmittance rate of the first patterned transparent region 16. On the other hand, the other portion of the non-display zone 14, excluding the first patterned transparent region 16, which has three layers of light shielding layer, including the light-shielding layer 22, the second patterned light-shielding layer 24 and the first patterned light-shielding layer 26, formed thereon will have a transmittance rate equal to a sum of the transmittance rates of said three layers of the light-shielding layer, namely a sum of the first transmittance rate, the second transmittance rate and the third transmittance rate, such that whose transmittance rate is less than the transmittance rate of the first patterned transparent region 16.

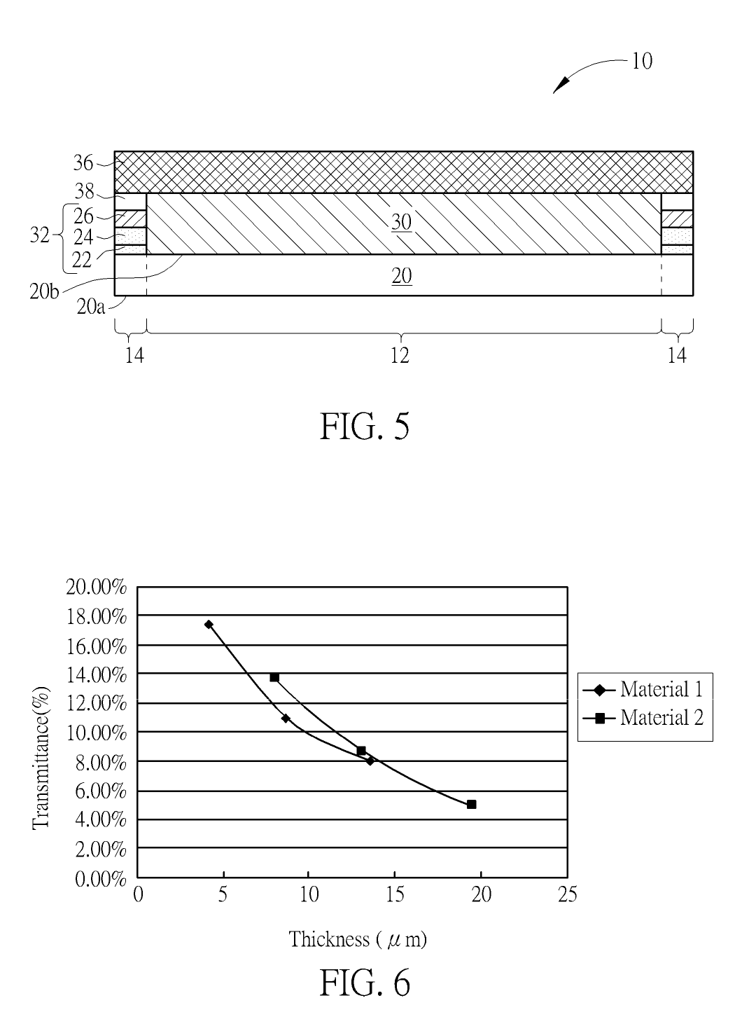

Referring to FIG. 5, FIG. 5 is a cross-sectional diagram of the cross line 4-4′ of the touch display panel shown in FIG. 1. After the touch sensing layer 28 is formed, a display module 36 can be further fabricated by either forming the display module 36 on the top surface 20b of the substrate 20 or attaching the substrate 20 on a surface of the display module 36. The display module 36 may include a display medium layer, a bottom substrate and a top substrate. As an example, the display module 36 may be a liquid crystal display module (LCDM), so that the display medium layer is a liquid crystal layer, elements such as common electrode(s) and color filter layer may be disposed on a surface of the bottom substrate, and elements such as switching elements and pixel electrodes may be disposed on a surface of the top substrate, but not limited thereto. As shown in FIG. 5, the light-shielding layer 22, the second patterned light-shielding layer 24 and the first patterned light-shielding layer 26 can be regarded a sheltering layer 32 of the non-display zone 14, for shielding the elements and circuits or wires disposed within the non-display zone 14. Additionally, the touch display panel 10 of the present invention further include a plurality of touch sensing elements 30 disposed between the substrate 20 and the display module 36, wherein the touch sensing elements 30 may include a material which is the same as the material of the touch sensing layer 28 or may be fabricated through the same process as the touch sensing layer 28. Furthermore, the touch sensing layer 28 is preferably electrically connected to at least one of the touch sensing elements 30, but not limited thereto. In practical use, the touch sensing elements 30 detect objects by a single or multiple touches on the display surface of the touch display panel 10, which is the bottom surface 20a, and then generate and transmit operation signals to the display module 36. Moreover, the touch display panel 10 can also include a sealant 38 disposed in the non-display zone 14 on the top surface 20b of the substrate 20, between the substrate 20 and the display module 36.

In accordance with the present invention, the light-shielding layer 22 within the first patterned transparent region 16 is regarded as a light guide film. While light illuminates the touch display panel 10 from the backside thereof (namely the top surface 20b of the substrate 20), the light will be guided in the light-shielding layer 22 to shown a uniform brightness in the first patterned transparent region 16, and therefore the touch display panel 10 shows the pattern of the first patterned transparent region 16 with even luminance at its front side (namely the bottom surface 20a of the substrate 20). Through the present invention, in order to obtain preferable light-guiding effect and transmittance rate of the light-shielding layer 22, the material, the concentration of the material, the layer thickness, and the particle size of the row material related to the light-shielding layer 22 have to be concerned. Since the material of the light-shielding layer 22 has been fully discussed in the aforementioned paragraphs, other parameters related to the transmittance rate of the light-shielding layer will be further introduced in the following introduction. Referring to FIG. 6, FIG. 6 is a graph illustrating a relation between the materials of the light-shielding layer and the thicknesses of coated layers, wherein a material 1 and a material 2 are provided respectively with the same material in various concentrations and particle sizes. The material 1 has fine particles and a more diluted concentration. In comparison with the material 1, the material 2 has bigger particles and a greater concentration. It is demonstrated that the material 1 can achieve a transmittance rate of about 17% to 8% while the coated layer is formed with a thickness of about 4 micrometers to 13 micrometers and the material 2 can achieve a transmittance rate of about 13% to 5% while the coated layer is formed with thickness of about 8 micrometers to 20 micrometers. As shown in FIG. 6, the transmittance rates decrease by the thickness of the coated layers in a non-linear manner. Hence, by adjusting the concentration of the coating material (such as ink), the particle size of the row material or the thickness of the coated layer, it is sufficient to modulate the transmittance rate of each coated layer. However, it is also believed that all of the concentration of the coating material, the particle size, and the fabrication method of the coated layer can be regarded as a parameter related to the thickness of the coated layer.

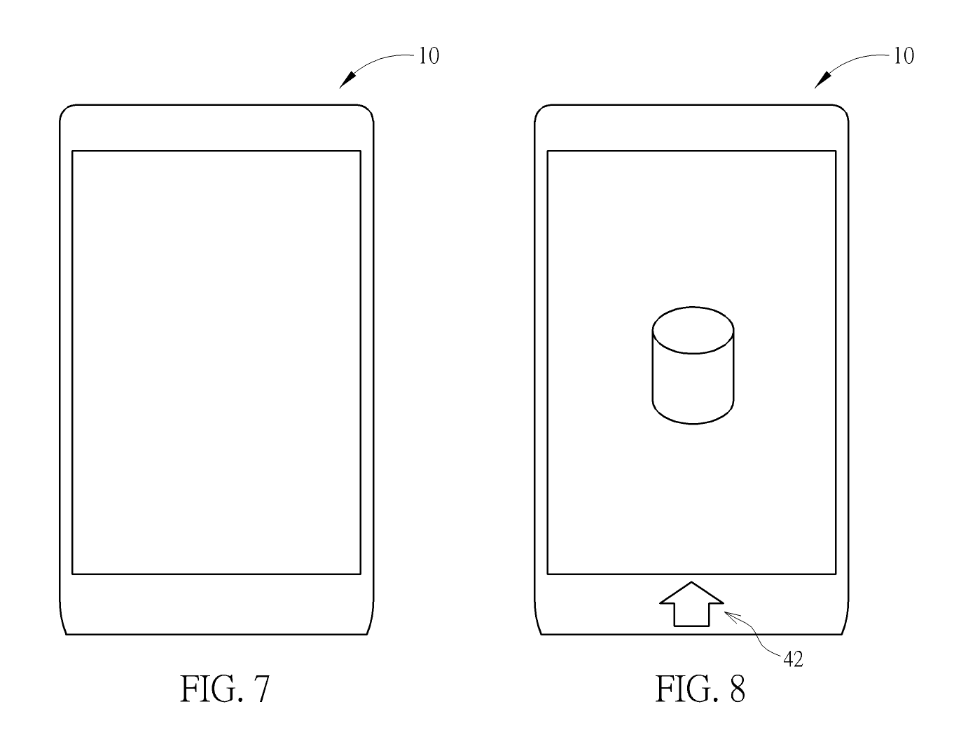

Referring to FIG. 7 and FIG. 8, FIG. 7 and FIG. 8 illustrate a schematic top view of the touch display panel 10 of the present invention in standby mode and operation mode respectively. In FIG. 7, the touch display panel 10 is in standby mode, thus the backlight of the touch button is turned off. Therefore, no light will illuminate out through the first patterned transparent region 16 (as shown in FIG. 1), and the pattern of the touch button cannot be seen from an outward appearance of the touch display panel 10. As shown in FIG. 8, the backlight of the touch button is turned on under operation mode, thus light will pass through the first patterned transparent region 16 to show the pattern of the first patterned transparent region 16. In this way, the touch button 42 with a shape the same as the pattern of the first patterned transparent region 16 can be seen from the outward appearance of the touch display panel 10.

However, the touch display panel of the present invention is not limited by the aforementioned embodiments and has other preferred embodiments which are disclosed in the following paragraphs. For making it easier to compare the difference between each embodiment, the following description will only detail the dissimilarities among those embodiments and the identical features will not be redundantly described. Please note that the same features among those embodiments are marked with the same number.

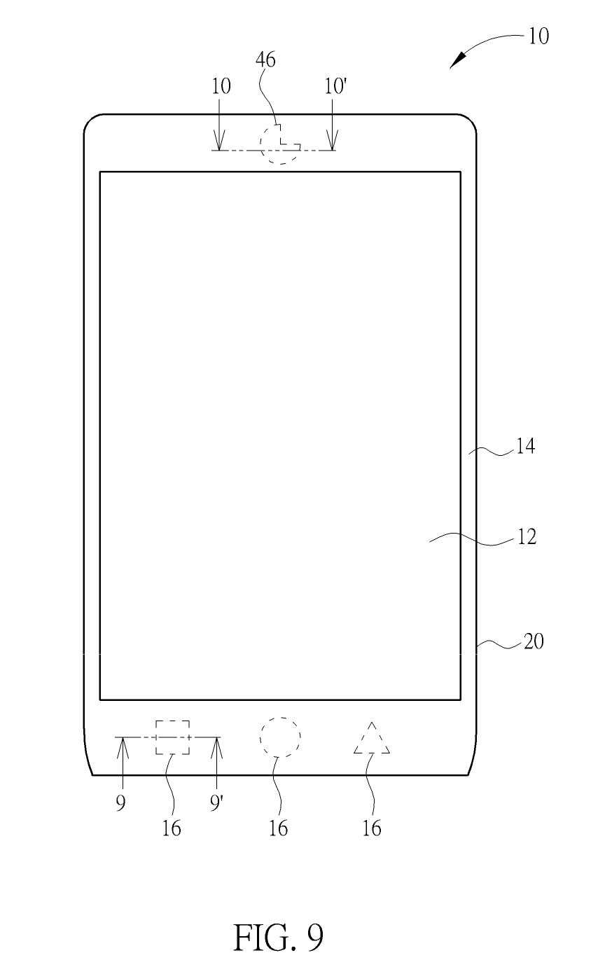

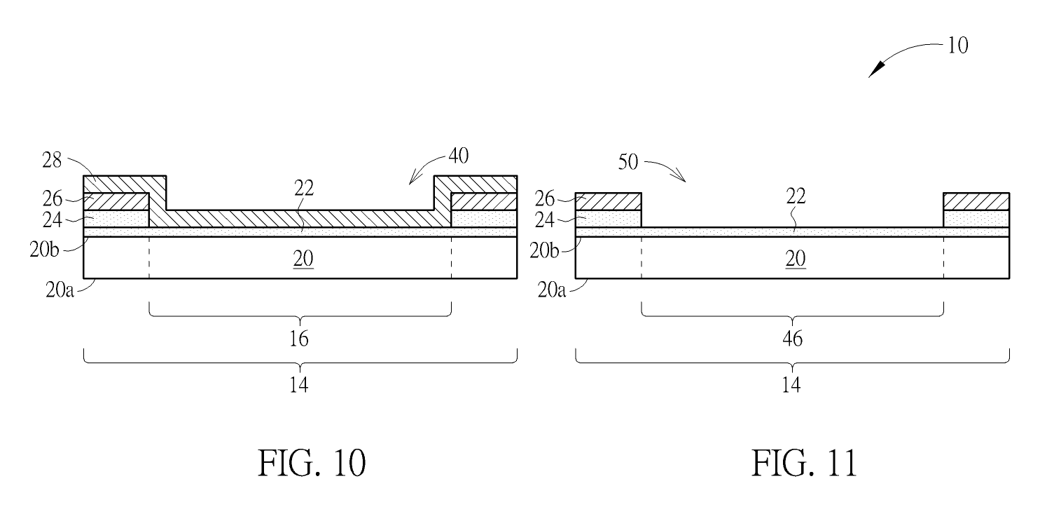

Referring to FIG. 9 to FIG. 10, FIG. 9 to FIG. 10 are diagrams of the touch display panel in the second embodiment of the present invention, wherein FIG. 9 is a schematic top view of an outward appearance of the touch display panel, and FIG. 10 and FIG. 11 are cross-sectional views along the cross line 9-9′ and the cross line 10-10′ of the touch display panel shown in FIG. 9 respectively. As shown in FIG. 9, the non-display zone 14 of the touch display panel 10 includes the first patterned transparent regions 16 with three different patterns and shapes, wherein the first patterned transparent regions 16 are regarded as the disposed regions for the touch buttons and also show the patterns of different touch buttons. In the present embodiment, the touch display panel 10 further includes a second patterned transparent region 46, wherein the second patterned transparent region 46 can be designed as an illuminating pattern which does not have touch function, such as a trademark or a model number, but not limited there to. In the present embodiment, the first patterned transparent regions 16 are disposed in a bottom part of the non-display zone 14 and the second patterned transparent region 46 is disposed in a top part of the non-display zone 14 due to various functions thereof, but not limited thereto. As shown in FIG. 10, the first patterned transparent region 16 of this embodiment has the same stacking structure of the coated layers (or light-shielding layers) thereon in comparison with the first embodiment as shown in FIG. 4. Furthermore, the touch sensing layer 28 can be disposed on the substrate 20 to cover the first patterned transparent region 16 and at least a portion of the first patterned light-shielding layer 26. In practical use, the touch sensing layer 28 can detect objects by a touch on the first patterned transparent region 16, and then generate and transmit operation signals to the touch display panel 10. On the other hand, as shown in FIG. 11, the second patterned transparent region 46 of the substrate 20 is also entirely covered with the light-shielding layer 22, and the second patterned light-shielding layer 24 and the first patterned light-shielding layer 26 are disposed in the non-display region 14 which does not have the second patterned transparent region 46, wherein the second patterned light-shielding layer 24 and the first patterned light-shielding layer 26 comprise an opening 50 corresponding to the second patterned transparent region 46. Namely, the portion of the light-shielding layer 22 within the second patterned transparent region 46 is exposed by the opening 50, and there are not any first and second patterned light-shielding layers 26 and 24 disposed within the second patterned transparent region 46. Therefore, the first transmittance rate of the light-shielding layer 22 is considered as the transmittance rate of the second patterned transparent region 46. In the present embodiment, the light-shielding layer 22 and the second patterned light-shielding layer 24 are both in white and the first patterned light-shielding layer 26 is in black. In other embodiment, the first patterned transparent region 16 and the second patterned transparent region 46 may include different numbers of coated layers or have different transmittance rates or non-identical colors, but not limited thereto.

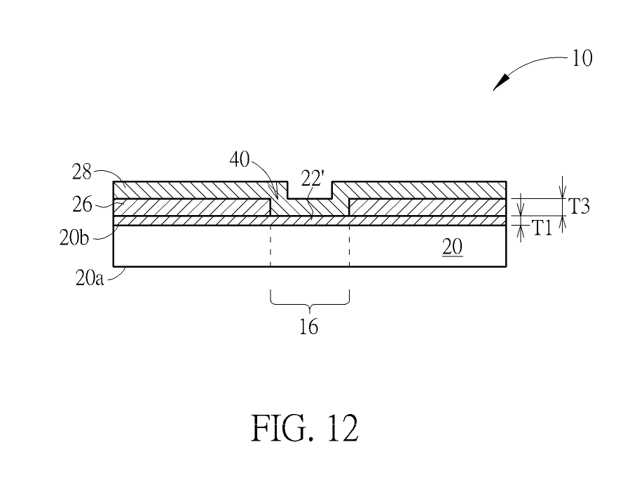

Referring to FIG. 12, FIG. 12 is a cross-sectional view of the touch display panel in the third embodiment of the present invention. The touch display panel 10 in the present embodiment does not have a second patterned light-shielding layer, and the light shielding layer 22′ and the first patterned light-shielding layer 26 include the same material or have the same color, such as black. Under such arrangement, the color of the first patterned light-shielding layer 26 will not be revealed from the light-shielding layer 22′, thus the second patterned light-shielding layer as described in the aforementioned embodiment is no longer requested. The light-shielding layer 22′ and the first patterned light-shielding layer 26 may include photoresist material, such as a black matrix (BM) photoresist material, being fabricated through photolithography processes. Detailed materials of the black photoresist material have been fully discussed in the aforementioned paragraphs. In order to provide preferable shielding effect, the thickness T3 of the first patterned light-shielding layer 26 can be further adjusted to be larger than the thickness T1 of the light-shielding layer 22′ such that the second transmittance rate of the first patterned light-shielding layer 26 can be substantially less than the first transmittance rate of the light-shielding layer 22′, but not limited thereto. The thickness T1 of the light-shielding layer 22′ can be about 0.3 to 1 micrometers and the first transmittance rate is about 10% to 20%. Preferably, the thickness T1 of the light-shielding layer 22′ is about 0.3 micrometers for example, and the first transmittance rate is about 10%. The thickness T3 of the first patterned light-shielding layer 26 can be about 1.2 micrometers for example, and the transmittance rate is about 0.01%. Likewise, in other embodiment, even if the light-shielding layer 22′ and the first patterned light-shielding layer 26 include different materials and colors, the second patterned light-shielding layer described in aforementioned embodiments can be still omitted (namely, having a similar structure to FIG. 12) while the color of the first patterned light-shielding layer 26 is not easy to be revealed from the light-shielding layer 22′ or the revealing color of the first patterned light-shielding layer 26 is acceptable. However, in some embodiments, even if the light-shielding layer 22′ and the first patterned light-shielding layer 26 are formed with the same materials, the touch display panel 10 can still include a second patterned light-shielding layer disposed between the light-shielding layer 22′ and the first patterned light-shielding layer 26, and the second patterned light-shielding layer may include the same material as the light-shielding layer 22′ and the first patterned light-shielding layer 26, but not limited thereto.

As summarized, according to the touch display panel disclosed by the present invention, the light-shielding layer which can be formed with a large area on the surface of the touch display panel is used for replacing the conventional light-guide film of an illuminating touch button, and the differences of the thickness and the transmittance rate between the first patterned transparent region and other portions of the non-display zone are utilized by disposing the first patterned light-shielding layer with an opening that exposes the first patterned transparent region, the first patterned transparent region can perform preferable transmittance rate and to function as an illuminating button on the touch display panel under the supplement of the backlight. In view of the touch display panel of the present invention, since the light-shielding layer is entirely formed on the substrate with a large area, it can effectively avoid serious aberration, so as to obtain vaguely revealing or hiding the button pattern under standby mode. Accordingly, the time-and-cost consuming process in conventional art, such as coating extra light guide film on the backside of the touch button, is no longer requested. In this way, the touch display panel of the present invention can achieve attractive appearance and cost reduction at the same time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch display panel, comprising:
a substrate, the substrate having a display zone and a non-display zone, wherein the non-display zone surrounds the display zone and the non-display zone includes at least one first patterned transparent region;
a plurality of touch sensing elements, the touch sensing elements being disposed within the display zone of the substrate;
a light-shielding layer, covering the non-display zone of the substrate and having a first transmittance rate; and
a first patterned light-shielding layer, partially covering the light-shielding layer, wherein the first patterned light-shielding layer is not disposed within the first patterned transparent region, and the first patterned light-shielding layer has a second transmittance rate substantially less than the first transmittance rate.

2. The touch display panel of claim 1, further comprising a second patterned light-shielding layer, the second patterned light-shielding layer being disposed between the light-shielding layer and the first patterned light-shielding layer and having a pattern which is the same as a pattern of the first patterned light-shielding layer, wherein the second patterned light-shielding layer has a third transmittance rate and the second transmittance rate is substantially less than a sum of the first transmittance rate and the third transmittance rate.

3. The touch display panel of claim 2, wherein the light-shielding layer and the second patterned light-shielding layer are made by the same materials, and the first transmittance rate is substantially equal to the third transmittance rate.

4. The touch display panel of claim 3, wherein the first patterned light-shielding layer comprises a material which is different from the material of the light-shielding layer.

5. The touch display panel of claim 3, wherein the materials of the light-shielding layer and the second patterned light-shielding layer comprise a white ink material or a white photoresist material.

6. The touch display panel of claim 5, wherein the white ink material comprises titanium dioxide and organic polyester resin, and the white photoresist material comprises titanium dioxide and acryl resin.

7. The touch display panel of claim 5, wherein the light-shielding layer has a thickness of about 4 micrometers to about 8 micrometers.

8. The touch display panel of claim 2, wherein the light-shielding has a thickness less than a thickness of the first patterned light-shielding layer or a thickness of the second patterned light-shielding layer.

9. The touch display panel of claim 1, wherein the light-shielding layer and the first patterned light-shielding layer are made by the same materials.

10. The touch display panel of claim 9, wherein the materials of the light-shielding layer and the first patterned light-shielding layer comprise a black ink material or a black photoresist material.

11. The touch display panel of claim 10, wherein the black ink material comprises carbon black and organic polyester resin, and the black photoresist material comprises carbon black and acryl resin.

12. The touch display panel of claim 10, wherein the light-shielding layer has a thickness of about 0.3 micrometers to about 1 micrometer.

13. The touch display panel of claim 1, wherein the first transmittance rate has a range substantially between about 10% and about 20%.

14. The touch display panel of claim 1 further comprising a touch sensing layer, wherein the touch sensing layer covers the first patterned transparent region and a portion of the first patterned light-shielding layer, and the touch sensing layer is electrically connected to the touch sensing elements.

15. The touch display panel of claim 1, wherein the non-display zone further comprises a second patterned transparent region and the second patterned transparent region has a pattern different from a pattern of the first patterned transparent region.

16. The touch display panel of claim 1 further comprising a display module, wherein the display module is disposed on the substrate and the touch sensing elements are sandwiched in between the substrate and the display module.
